(19) United States
(12) Patent Application Publication
(10) Pub. No.: US 2002/0178519 A1
(43) Pub. Date: Dec. 5, 2002

(54) Electric tooth flossing and brushing apparatus

(76) Inventor: Vincent Zarlengo, Sun Valley, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/150,897

(22) Filed: May 16, 2002

Related U.S. Application Data
(60) Provisional application No. 60/291,368, filed on May 16, 2001.

(51) Int. Cl. A61C 17/34; A61C 15/04

(52) U.S. Cl. 15/22.2; 15/22.1; 132/322; 132/309

(57) ABSTRACT

An electric tooth flossing and brushing apparatus includes a crown having teeth engaged with a pinion of an electric motor so as to be rotatably driven by the motor. A brush drive housing has an end associated with a cam rotatably associated with the crown. The brush drive housing is configured to move generally transverse to a longitudinal axis thereof as the cam is rotated. A floss drive rod also has an end associated with the cam, but is configured to move generally parallel to a longitudinal axis thereof as the cam is rotated. Thus, as the crown is rotated, the floss drive rod and brush drive housing simultaneously move independently of one another, allowing a brush head to be placed on the brush drive housing and have appropriate brushing movement, or a floss unit to be attached to the floss drive rod and have appropriate flossing movement.

### RELATED APPLICATION

This application claims priority from U.S. Provisional Application Serial No. 60/291,368, filed May 16, 2001.

### BACKGROUND OF THE INVENTION

The present invention relates generally to tooth brushes and flossing devices. More particularly, the present invention relates to a combined electric tooth flosser and brusher device.

For oral hygiene purposes, the teeth are frequently brushed with a toothbrush having a bristle head. Toothpaste is typically applied to the bristles and the brush moved across the surface of the teeth in a rotational fashion to remove plaque and the like from the surface of the teeth. Recently, electronic devices have been devised wherein disposable brush heads can be inserted upon a handle having an electrical motor therein which vibrates or otherwise causes the brush head to move so that not as much effort is placed into brushing one's teeth, and a more effective job is performed in the same amount of time.

Dentists also recommend flossing between one's teeth to remove debris and plaque from the surfaces of the teeth which are otherwise inaccessible by the toothbrush. Floss is sold in spools which can be cut to the appropriate length and wrapped between one's fingers for flossing. There are also disposable “flossing swords” in which a length of floss is strung across a member attached to a handle so that the user need not wrap the floss between his or her fingers. There also exist devices wherein the floss can be wrapped about a generally U-shaped member and attached to an electrical device, as described above, which moves the floss as the user inserts the floss between his or her teeth.

These hand-held electrical devices can be quite expensive. Due to the fact that the brushing devices require movement transverse to the longitudinal axis of the disposable brush head, and preferably some degree of rotational movement as well, while the flosser devices require axial movement along the longitudinal axis of the flosser attachment, these devices have been created with drive assemblies which are not capable of performing both movements at the same time. Thus, a potential consumer must purchase a hand-held electric brushing device, and a separate hand-held electric flossing device. Aside from the expense of purchasing two separate devices, the disadvantage is compounded by the fact that both devices must be stored so as to be accessible on a daily basis.

Accordingly, there is a need for a hand-held electrical device which is capable of accommodating both disposable toothbrush heads, as well as disposable flossers, while providing the necessary movement for each. The present invention fulfills this need and provides other related advantages.

### SUMMARY OF THE INVENTION

The present invention resides in an electric tooth flossing and brushing apparatus providing independent dual movement so that the device can either support a floss unit and move the floss unit in a traditional flossing direction, or a toothbrush head and move the toothbrush head in a traditional brushing pattern.

A handle of the device of the apparatus houses a battery connected to a motor. Preferably, the battery is rechargeable, and the handle includes an inductive coil connected to the battery. In this manner, the handle may be placed upon an inductive charger base to recharge the battery.

An electric motor is connected to the battery and has a pinion extending therefrom and engaged with teeth of a crown, so that the motor rotatably drives the crown. A cam is associated with the crown and rotatable therewith. A brush drive housing has an end associated with the cam and is configured to move generally transverse to a longitudinal axis thereof as the cam is rotated. A floss drive rod has an end associated with the cam that is configured to move generally parallel to the longitudinal axis thereof as the cam is rotated. The brush drive housing and floss drive rod are arranged such that as the crown is rotated, the floss drive rod and the brush drive housing simultaneously move independently of one another.

In a particularly preferred embodiment, the end of the brush drive housing associated with the cam forms an aperture having a primary width axis that is generally aligned with the longitudinal axis of the brush drive housing. The end of the floss drive rod associated with the cam forms an aperture having a primary width axis that is generally transverse to the longitudinal axis of the floss drive rod. Thus, as the cam is rotated, the brush drive housing and floss drive rod move in opposite directions simultaneously. Thus, a floss unit may be detachably connected to the floss drive rod, such as by inserting the end of the floss unit into an aperture formed in an end of the floss drive rod generally opposite the cam, and the floss unit will move in a back and forth movement appropriate for flossing. Alternatively, a brush head may be detachably connected to the brush drive housing, such as by frictionally engaging a skirt of the brush head with the brush drive housing, causing the brush head to move in an up and down brushing motion without having any flossing motion imparted thereto.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrates the invention. In such drawings:

FIG. 1 is a perspective view of an electric tooth flossing and brushing apparatus embodying the present invention, positioned on a wall-mounted recharging unit, and having a detachable brush head attached thereto;

FIG. 2 is a partially exploded perspective view of the apparatus of FIG. 1, illustrating the attachment of either a brush head or floss unit;

FIG. 3 is a schematic diagram of a drive mechanism of the present invention;

FIG. 4 is a top planar view of a floss drive rod attached to the drive mechanism and having a floss unit attached thereto;

FIG. 5 is a top view of an alternative floss drive rod associated with the drive mechanism;

FIG. 6 is a perspective view of the floss drive rod of FIG. 5 connected to the drive mechanism;

FIG. 7 is a top view of a brush head associated with the drive mechanism;

FIG. 8 is a top view of a brush drive housing overlying the floss drive rod of FIG. 6, and associated with the drive mechanism;

FIG. 9 is a perspective view of the drive mechanism, floss drive rod, and brush drive housing arrangement of FIG. 8;

FIGS. 10 and 11 are top view diagrams illustrating a cam of the drive mechanism rotating, causing the brush drive housing to move against its longitudinal axis, and the floss drive rod to move along the length of the longitudinal axis thereof;

FIG. 12 is a cross-sectional view taken generally along line 12-12 of FIG. 9, illustrating movement of the brush drive housing and floss drive rod; and

FIG. 13 is a cross-sectional view taken generally along line 13-13 of FIG. 9, illustrating additional movement of the brush drive housing and floss drive rod of the present invention.

### DETAILED DESCRIPTION OF THE PREFERRED EMBODIMENTS

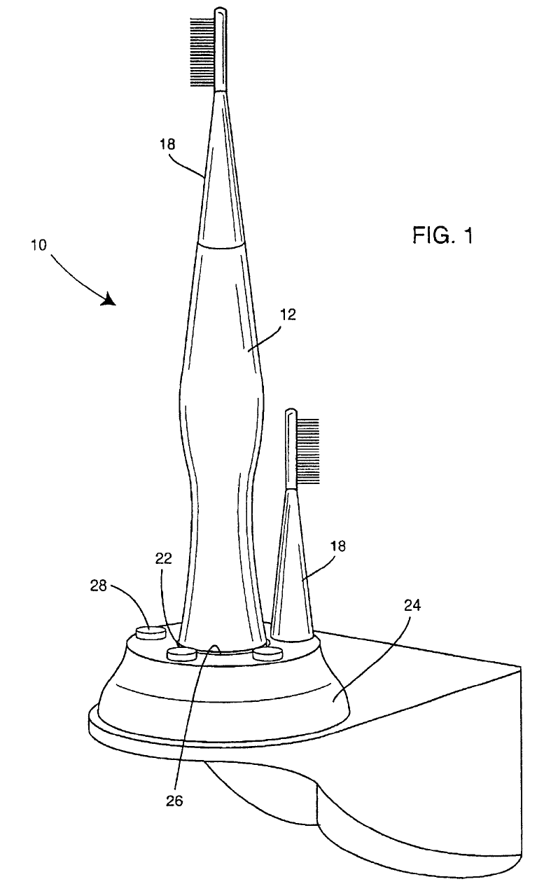

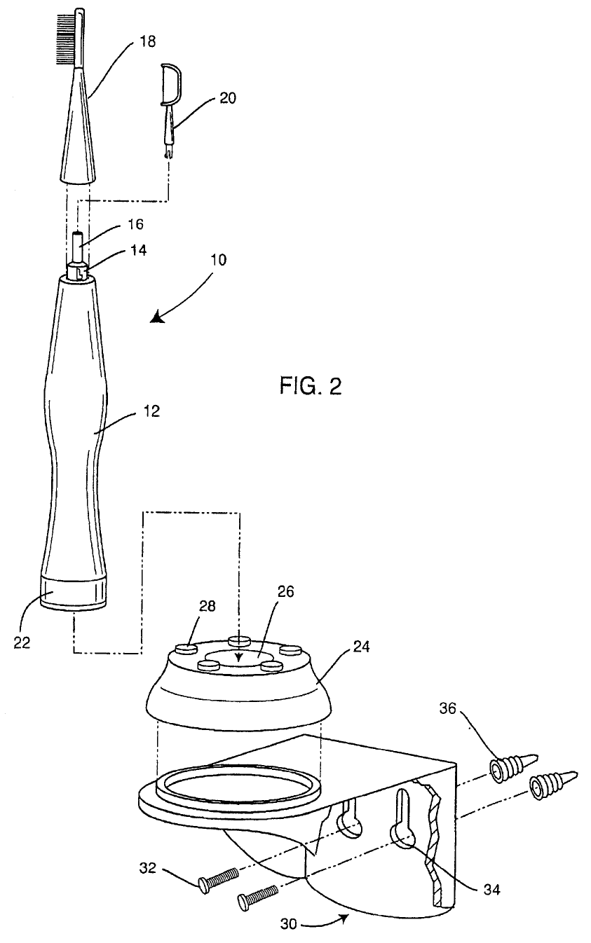

As shown in the drawings for purposes of illustration, the present invention resides in an electric tooth flossing and brushing apparatus, generally referred to by the reference number 10. With reference to FIGS. 1 and 2, the hand-held apparatus 10 includes an ergonomically designed housing 12 which serves as a handle having an internal battery section, external on/off button, internal motor section and an internal drive section. As will be described more fully herein, the drive section is operably connected to a brush drive housing 14 and floss drive rod 16 which move independently and move either an attached brusher head 18 or floss unit 20, respectively, with the appropriate movement.

With continuing reference to FIGS. 1 and 2, although the apparatus 10 can be powered by a disposable battery (not shown), preferably the handle 12 houses an induction charger 22 in an end thereof comprised of a plurality of windings of electrically conductive wire connected to a rechargeable battery. The apparatus 10 in a particularly preferred embodiment can be stored on an induction charger base 24 having an electrical cord and plug for insertion into a standard electrical outlet. The induction charger base 24 includes a coiled wire therein which create electric flux when powered. The induction charger base 24 includes a central recess 26 into which the base of the apparatus 10 can be inserted. The wires of the induction charger 22 of the apparatus 10 is charged from the electric flux generated by the induction charger base 24. Of course, other methods of powering the apparatus 10 can be utilized, such as a power cord or disposable batteries.

With continuing reference to FIGS. 1 and 2, the induction charger base 24 preferably includes vertical protrusions 28 which are sized and configured to hold detachable brush heads 18. Thus, as the apparatus 10 is being recharged, the brush heads 18 can be placed upon one of the vertical protrusions 28 for convenience. Preferably, the apparatus 10 is provided with several disposable brush heads 18, which can be color-coded so that more than one consumer can utilize the apparatus 10 while having his or her personal brush head 18. The vertical protrusions 28 enable the temporary storage of the brush heads 18 when not in use.

As shown in FIG. 2, the induction charger base 24 can be attached to a wall-mounting unit 30. The wall-mounting unit 30 is configured to receive and interlock with the induction charger base 24 and accept screws 32 through apertures 34 formed in the wall-mounting unit 30 and into a vertical surface, such as a bathroom wall. As bathroom walls are typically comprised of sheet rock or the like, holes can be predrilled into the sheet rock and sheet rock anchors 36 can be inserted therein prior to installation of the wall-mounting unit 30.

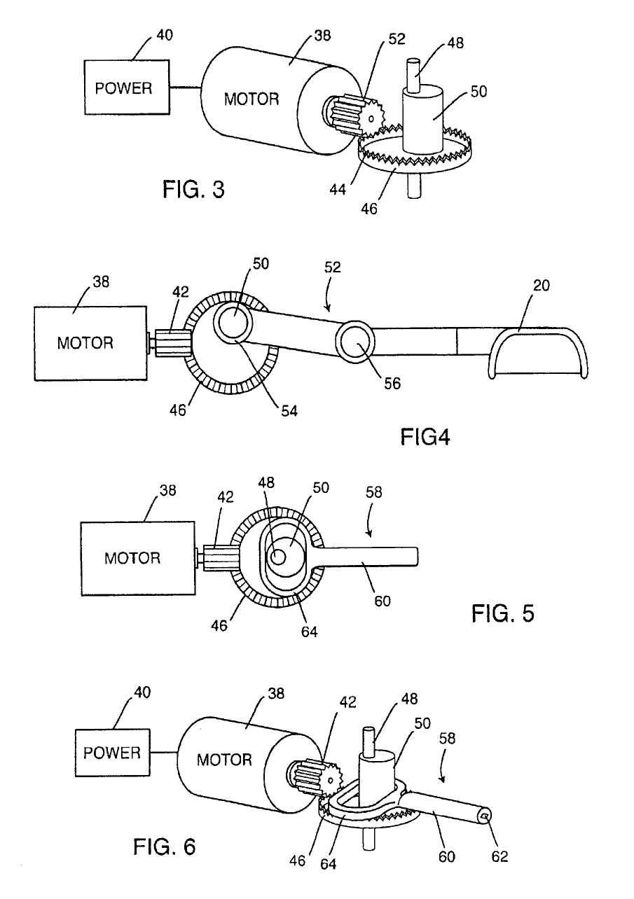

With reference now to FIG. 3, a drive assembly of the present invention is illustrated having a motor 38 in electrical connection with a battery or other appropriate power source 40, and having a pinion gear 42 extending therefrom. The teeth of the pinion 42 are in operable contact with teeth 44 of a circular crown 46. An axle 48 extends through the crown 46 and supports a cam 50 comprised of a mass which is eccentric to the axle 48 and center of rotation of the crown 46. Thus, as the motor 38 is activated, the pinion 42 rotates, resulting in the rotation of the crown 46, axle 48 and cam 50. As will be more fully described herein, the configuration of the drive assembly provides dual movement necessary to operate both the brush head 18 and floss unit 20.

It is well-known that flossing movement comprises a back and forth movement of a flosser such that the dental floss associated with the flosser moves between the teeth of the user to remove debris, etc. Thus, the drive assembly of the present invention must impart this in-line, back and forth movement to the floss unit 20. As shown in FIG. 4, a floss drive rod 52 includes an end having an circular aperture 54 that fits over the cam 50 and includes a joint 56 which translates the rotational movement of the cam 50 into linear movement along the longitudinal axis of the flosser drive rod 52. As shown in FIG. 4, the flosser unit 20 is removably attached to the floss rod 52 at an end thereof opposite the cam 50.

With reference now to FIGS. 5 and 6, a particularly preferred configuration of a flosser drive rod 58 is illustrated. The flosser drive rod 58 includes a relatively thin stem portion 60 having an aperture 62 at an end thereof for receipt of the floss unit 20. At the opposite end of the floss drive rod is formed an irregular loop or aperture 64 having a primary width axis that is generally transverse to the longitudinal axis of the stem 60. Thus, as the cam 50 is rotated, the floss drive rod 58 moves along its longitudinal axis due to the configuration of the loop or aperture 64. This configuration enables the flosser drive rod 58 to achieve movement along its longitudinal axis without the need for the joint 56 described above. Due to the elongated nature of the loop or aperture 64, there is little or no movement in the transverse direction. This is intended as a flosser unit 20 needs to move generally axially during use.

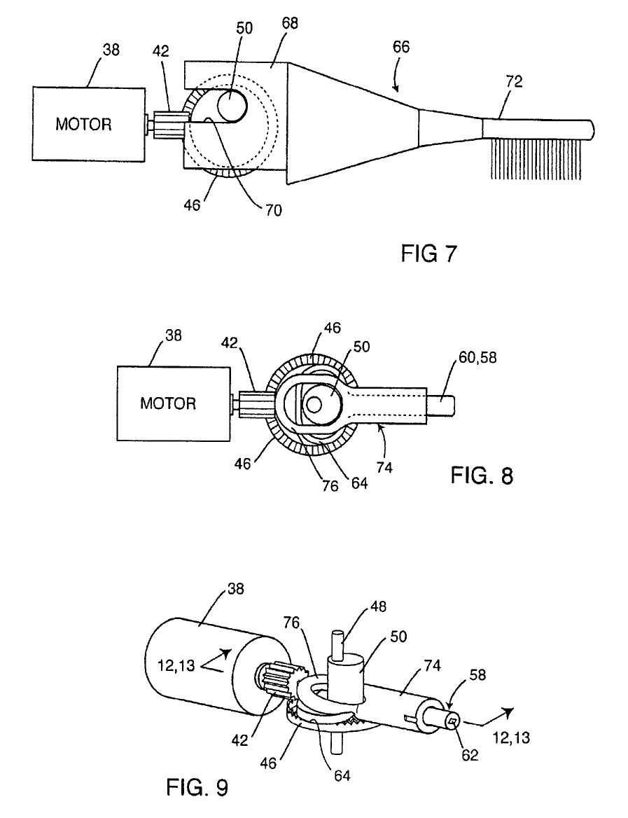

Referring now to FIG. 7, a brush head 66 having a hollow and elongated skirt 68 that defines an elongated aperture 70 into which the cam 50 is inserted is shown. Elongated aperture 70 has an axis that coincides or runs parallel to the longitudinal axis of the brush head 66. As the crown gear 46 rotates, the cam 50 also rotates resulting in movement of the brush head 66 which is transverse to its longitudinal axis. This movement results due to the contact of the cam 50 with the brush head skirt 68 defining the elongated aperture 70. Due to the elongated nature of the aperture 70, movement of the brush head 66 occurs minimally, or not at all, at the elongated portions of the aperture 70, whereas the cam 50 contacts and pushes the brush head 66 to an increasing degree along the secondary axis of the elongated aperture 70 as the cam 50 is rotated. The skirt portion 68 defining the elongated aperture 70 is preferably slightly curved, so that not only is transverse movement realized, but also a degree of rotational movement as is necessary for brushing. The curved, hollow design of the brush head skirt 68 also enables a floss drive rod 52 or 58 to be simultaneously attached to the cam 50. The conical skirt portion 68 can be in contact with the drive assembly at all times, with a brush head 72 being detachably connected thereto. This would enable the flosser drive rod 52 or 58 to be simultaneously attached to the cam 50 and reside within the hollow conical skirt 68, allowing the user of the apparatus 10 to merely attach either the brush head 72 or flosser unit 20 to either the brush head skirt 68 or floss drive rod 52 or 58.

With reference now to FIGS. 8 and 9, a particularly preferred embodiment of the present invention is shown wherein a brush drive housing 74 has an end defining an elliptical loop or aperture 76 having a primary axis which runs normal to the longitudinal axis of the brush drive housing. This loop or aperture 76 is fit over the cam 50 so that as the cam 50 is rotated, the brush drive housing 74 experiences movement transverse to its longitudinal axis, or up and down movement with a slight degree of rotational movement which is appropriate for brushing.

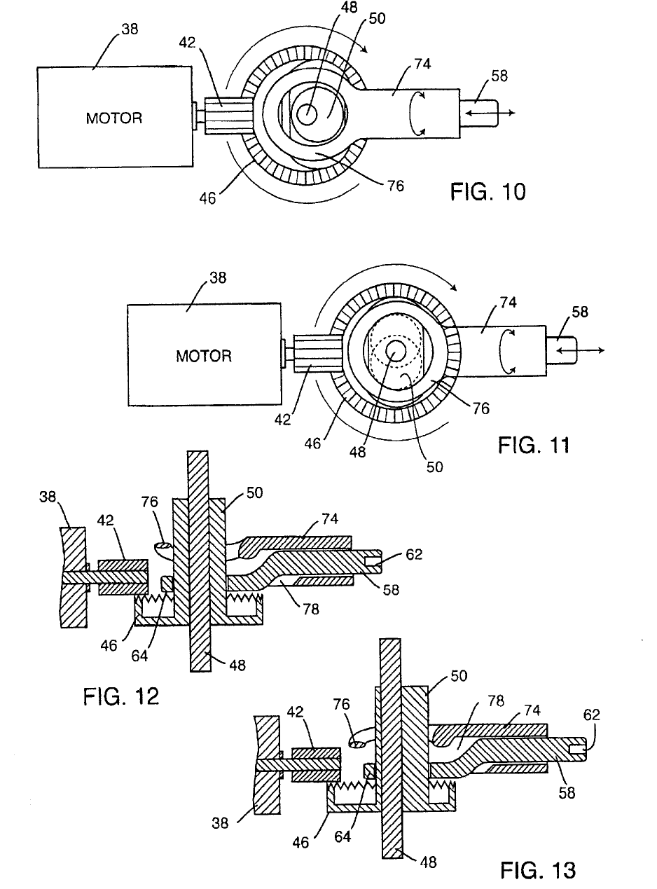

With reference now to FIGS. 12 and 13, the brush drive housing 74 includes an elongated aperture 78 therethrough sized to receive the stem 60 of the floss drive rod 58. The aperture 78 is of a slightly larger diameter than the outer diameter of the stem 60 such that the stem 60 can move freely within the brush drive housing 74. Thus, as shown in FIGS. 8-13, the flosser drive rod 58 is inserted through the hollow brush drive housing 74, and the brush drive aperture 76 is placed onto the cam 50 so that both the flosser drive rod 58 and brush drive housing 74 are operably connected to the cam 50 simultaneously. As with the previously described embodiments, when the motor 38 is powered on and pinion gear42 rotated, the crown 46 rotates causing the cam 50 to rotate as well. The cam 50 contacts the portions of the flosser drive rod 58 and brush drive housing 74, as described above, as it rotates, as illustrated in FIGS. 10 and 11, causing the flosser drive rod to experience linear motion, while the brush drive housing 74 simultaneously experiences transverse and rotational movements.

Referring back to FIGS. 1 and 2, a disposable brush head 18 having a conical skirt frictionally fits over the brush drive 74 while avoiding contact with the flosser drive rod 58. Thus, when the motor 38 is actuated, the disposable brush head 18 is moved only by the brush drive housing 74 movement, which is appropriate for brushing. As shown in FIG. 2, the brush head 18 can be removed from the brush drive housing 74 by merely pulling the brush head 18 from its frictional fit therewith. A disposable floss unit 20 can then be inserted into the aperture 62 at the end of the floss drive rod 58. The floss unit 20 is moved back and forth along its longitudinal axis as the motor 38 is actuated due to its sole connection with the flosser drive rod 58. The brush head 18 and flosser unit 20 include detents, expandable members, or the like so as to be retained in a tight fit with either the brush drive housing 74 or flosser drive rod 58, respectively, until intentionally removed therefrom.

It will be understood that the brush drive housing 74 experiences its movement at the same time that the flosser drive rod 58 experiences its movement. However, due to the selective attachment of either the brush head 18 to the brush drive housing 74, or the flosser unit 20 to the flosser connecting drive rod 58, the desired movement for the particular task can be selected. Thus, a consumer is able to purchase a single hand-held electric tooth flossing and brushing apparatus 10 which is capable of operating both brush heads 18 and floss units 20. This presents an enormous cost savings to the consumer, as well as added convenience.

Although several embodiments of the present invention have been described in detail for purposes of illustration, various modifications of each may be made without departing from the spirit and scope of the invention. Accordingly, the invention is not to be limited, except as by the appended claims.

What is claimed is:

1. An electric tooth flossing and brushing apparatus, comprising:
a cam rotatably driven by a motor;
a brush drive housing having an end associated with the cam and configured to move generally transverse to a longitudinal axis thereof as the cam is rotated; and
a floss drive rod having an end associated with the cam and configured to move generally parallel to a longitudinal axis thereof as the cam is rotated;
wherein as the cam is rotated, the floss drive rod and the brush drive housing simultaneously move independently of one another.

2. The apparatus of claim 1, including a pinion extending from the motor and engaged with teeth of a rotatable crown supporting the cam.

3. The apparatus of claim 1, wherein the end of the brush drive housing associated with the cam forms an aperture having a primary width axis that is generally aligned with the longitudinal axis of the brush drive housing.

4. The apparatus of claim 1, wherein the end of the floss drive rod associated with the cam forms an aperture having a primary width axis that is generally transverse with the longitudinal axis of the floss drive rod.

5. The apparatus of claim 1, including a floss unit detachably connected to the floss drive rod.

6. The apparatus of claim 5, wherein an end of the floss unit is detachably received in an aperture formed in an end of the floss drive rod generally opposite the cam.

7. The apparatus of claim 1, including a brush head detachably connected to the brush drive housing.

8. The apparatus of claim 7, wherein the brush head has a skirt extending therefrom for frictional engagement with the brush drive housing.

9. The apparatus of claim 2, including a handle housing a battery connected to the motor, the pinion, the crown and the cam.

10. The apparatus of claim 9, including an inductive coil disposed in the handle and connected to the battery.

11. The apparatus of claim 10, including an inductive charger base configured to receive the handle.

12. An electric tooth flossing and brushing apparatus, comprising:
a crown having teeth engaged with a pinion of a motor so as to be rotatably driven by the motor;
a cam associated with the crown and rotatable therewith;
a brush drive housing having an aperture at an end thereof associated with the cam and configured to cause the brush drive housing to move generally transverse to a longitudinal axis thereof as the cam is rotated; and
a floss drive rod having an aperture at an end thereof associated with the cam and configured to cause the floss drive rod to move generally parallel to a longitudinal axis thereof as the cam is rotated;
wherein as the crown is rotated, the floss drive rod and the brush drive housing simultaneously move independently of one another, allowing a brush head to be attached to the brush drive housing and have appropriate brushing movement, or a floss unit to be attached to the floss drive rod and have appropriate flossing movement.

13. The apparatus of claim 12, wherein the end of the brush drive housing defines an aperture having a primary width axis that is generally aligned with the longitudinal axis of the brush drive housing.

14. The apparatus of claim 12, wherein the end of the floss drive rod defines an aperture having a primary width axis that is generally transverse to the longitudinal axis of the floss drive rod.

15. The apparatus of claim 12, including a floss unit having an end thereof detachably received in an aperture formed in an end of the floss drive rod generally opposite the cam.

16. The apparatus of claim 12, including a brush head having a skirt extending therefrom for frictional engagement with the brush drive housing.

17. The apparatus of claim 12, including a handle housing a battery connected to the motor, the pinion, the crown and the cam.

18. The apparatus of claim 17, including an inductive coil disposed in the handle and connected to the battery.

19. The apparatus of claim 18, including an inductive charger base configured to receive the handle.

20. An electric tooth flossing and brushing apparatus, comprising:
a crown having teeth engaged with a pinion of a motor so as to be rotatably driven by the motor;
a cam associated with the crown and rotatable therewith;
a brush drive housing having an aperture at an end thereof associated with the cam, the aperture having a primary width axis that is generally aligned with the longitudinal axis of the brush drive housing, causing the brush drive housing to move generally transverse to a longitudinal axis thereof as the cam is rotated;
a floss drive rod having an aperture at an end thereof associated with the cam, the floss drive aperture having a primary width axis that is generally transverse to the longitudinal axis of the floss drive rod, causing the floss drive rod to move generally parallel to a longitudinal axis thereof as the cam is rotated;
a floss unit detachably connected to an end of the floss drive rod generally opposite the cam; and
a brush head detachably connected to the brush drive housing;
wherein as the crown is rotated, the floss drive rod and the brush drive housing simultaneously move independently of one another, allowing the brush head to be attached to the brush drive housing and have appropriate brushing movement, or the floss unit to be attached to the floss drive rod and have appropriate flossing movement.

21. The apparatus of claim 20, wherein an end of the floss unit is detachably received in an aperture formed in an end of the floss drive rod generally opposite the cam.

22. The apparatus of claim 20, wherein the brush head has a skirt extending therefrom for frictional engagement with the brush drive housing.

23. The apparatus of claim 20, including a handle housing an inductive coil, a battery connected to the inductive coil, the motor electrically connected to the battery, the pinion, the crown and the cam.

24. The apparatus of claim 23, including an inductive charger base configured to receive the handle.
